(19) United States
(12) Patent Application Publication
(10) Pub. No.: US 2026/0014871 A1
(43) Pub. Date: Jan. 15, 2026

(54) VEHICLE CONTROL DEVICE AND VEHICLE CONTROL METHOD

(71) Applicant: DENSO CORPORATION, Kariya-city (JP)

(72) Inventors: Hideyuki HONYA, Kariya-city (JP); Yasuaki KURITA, Kariya-city (JP); Kei OKADA, Kariya-city (JP)

(21) Appl. No.: 19/335,743

(22) Filed: Sep. 22, 2025

Related U.S. Application Data
(63) Continuation of application No. PCT/JP2024/011629, filed on Mar. 25, 2024.

(30) Foreign Application Priority Data
Mar. 28, 2023 (JP) 2023-051740

(51) Int. Cl. B60K 35/80; G06F 21/62

(52) U.S. Cl. CPC B60K 35/80; G06F 21/629

(57) ABSTRACT

A vehicle control device is configured to perform at least one of: executing control of vehicle equipment possessed by the vehicle, and managing a state of the vehicle equipment, receive, from a service providing unit that executes application software, a first command, which is described in a standardized format and requests implementation of a target function utilizing the vehicle equipment, convert the first command into a second command, determine whether the target function can be implemented, cause an equipment management unit to execute an instruction according to the second command, and transmit, together with a nonconformity reason indicating a reason for infeasibility, suggestion information indicating requirement necessary for the target function to be determined feasible, to a requester of the first command.

### CROSS REFERENCE TO RELATED APPLICATION

The present application is a continuation application of International Patent Application No. PCT/JP2024/011619 filed on Mar. 25, 2024 which designated the U. S. and claims the benefit of priority from Japanese Patent Application No. 2023-051740 filed on Mar. 28, 2023. The entire disclosures of all of the above applications are incorporated herein by reference.

### TECHNICAL FIELD

The present disclosure relates to a technology for processing requests from application software that provides services utilizing vehicle functions.

### BACKGROUND

A related art describes a technology in which, when application software (hereinafter referred to as “app”) that provides services utilizing vehicle functions accesses vehicle functions within a vehicle system, it is determined whether or not the request can be accepted, and the result of this determination is returned to the requesting app. Conventionally, apps have been provided by so-called OEMs, such as vehicle manufacturers, who are well acquainted with the characteristics, equipment, and constraints of vehicle control systems. However, it is anticipated that, going forward, a variety of service providers other than OEMs, known as third parties, will also enter the market. OEM stands for Original Equipment Manufacturer.

### SUMMARY

According to an aspect of the present disclosure, a vehicle control device mounted on a vehicle includes at least one of (i) a circuit and (ii) a processor with a memory storing computer program code executable by the processor. The at least one of the circuit and the processor is configured to cause the vehicle control device to: perform at least one of: executing control of vehicle equipment possessed by the vehicle, and managing a state of the vehicle equipment; receive, from a service providing unit that executes application software, a first command, which is described in a standardized format and requests implementation of a target function utilizing the vehicle equipment, and to convert the first command into a second command described in a format executable by the vehicle; and determine whether the target function can be implemented, and, when implementation is possible, to cause the vehicle control device to execute an instruction according to the second command, and when the implementation is not possible, to transmit, together with a nonconformity reason indicating a reason for infeasibility, suggestion information indicating requirement necessary for the target function to be determined feasible, to a requester of the first command. The nonconformity reason includes: an equipment nonconformity indicating that the vehicle equipment is unsuitable for implementing the target function; a scene nonconformity indicating that a scene identified from the state of the vehicle is unsuitable for implementing the target function; and an authorization nonconformity indicating that the requester of the first command does not have authority to use the target function. The at least one of the circuit and the processor is configured to add the suggestion information when the nonconformity reason is either the equipment nonconformity or the scene nonconformity.

### BRIEF DESCRIPTION OF DRAWINGS

Objects, features and advantages of the present disclosure will become more apparent from the following detailed description made with reference to the accompanying drawings. In the drawings:

FIG. 1 is a block diagram showing the configuration of the vehicle control system;

FIG. 2 is a block diagram showing the configuration of the ECU;

FIG. 3 is a block diagram showing the configuration of the center;

FIG. 4 is a flowchart showing the first determination process executed by the vehicle service unit;

FIG. 5 is a flowchart showing the second determination process executed by the state management unit;

FIG. 6 is a sequence diagram showing the flow of basic processing executed in the vehicle control system; and

FIG. 7 is a sequence diagram showing the processing flow in the vehicle control system when a request from the service providing unit is non-compliant.

### DETAILED DESCRIPTION

Incidentally, even after launching an app in the market, service providers need to continually verify whether the app is operating as intended and make improvements to further enhance the app's quality and value provided. The determination results obtained from conventional technologies can serve as useful information when improving the app.

However, service providers other than OEMs do not necessarily have a thorough understanding of the characteristics, equipment, constraints, and other aspects of the vehicle control system. Therefore, it has been found that simply providing the result of the acceptability determination for requests from the app makes it difficult to accurately grasp the operating status of the app or areas needing improvement.

The present disclosure provides a technology that facilitates the acquisition of information necessary for improving application software and the like.

According to one aspect of the present disclosure, a vehicle control device mounted on a vehicle comprises: an equipment management unit configured to perform at least one of executing control of vehicle equipment possessed by the vehicle and managing a state of the vehicle equipment; a reception unit configured to receive, from a service providing unit that executes application software, a first command, which is described in a standardized format and requests implementation of a target function utilizing the vehicle equipment, and to convert the first command into a second command described in a format executable by the vehicle; and a determination unit configured to determine whether the target function can be implemented, and, when implementation is possible, to cause the equipment management unit to execute an instruction according to the second command, and when the implementation is not possible, to transmit, together with a nonconformity reason indicating a reason for infeasibility, suggestion information indicating requirement necessary for the target function to be determined feasible, to a requester of the first command. The nonconformity reason may include: an equipment nonconformity indicating that the vehicle equipment is unsuitable for implementing the target function; a scene nonconformity indicating that a scene identified from the state of the vehicle is unsuitable for implementing the target function; and an authorization nonconformity indicating that the requester of the first command does not have authority to use the target function. The determination unit may add the suggestion information when the nonconformity reason is either the equipment nonconformity or the scene nonconformity.

According to such a configuration, areas of the application software that require improvement can be accurately identified, which can contribute to improving the quality of the application program.

According to one aspect of the present disclosure, a vehicle control method for a vehicle comprising an equipment management unit configured to perform at least one of execution of control of vehicle equipment and management of a state of the vehicle equipment comprises: receiving, from a service providing unit that executes application software, a first command described in a standardized format and requesting implementation of a target function that utilizes the vehicle equipment, and converting the first command into a second command described in a format executable by the vehicle; and determining whether the target function can be implemented, causing the equipment management unit to execute an instruction according to the second command when implementation is possible, and notifying, together with a nonconformity reason indicating a reason for infeasibility, suggestion information indicating requirement necessary for the target function to be determined feasible, to a requester of the first command when implementation is not possible. The nonconformity reason may include an equipment nonconformity indicating that the vehicle equipment is unsuitable for implementing the target function; a scene nonconformity indicating that a scene identified from the state of the vehicle is unsuitable for implementing the target function; and an authorization nonconformity indicating that the requester of the first command does not have authority to use the target function. When the nonconformity reason is either the equipment nonconformity or the scene nonconformity, the suggestion information is added to a notification to the requester of the first command.

According to the above vehicle control method, the same effects as those of the above-mentioned vehicle control device can be achieved.

The embodiments of the present disclosure will be described below with reference to the drawings.

### (Configuration)

### (System Configuration)

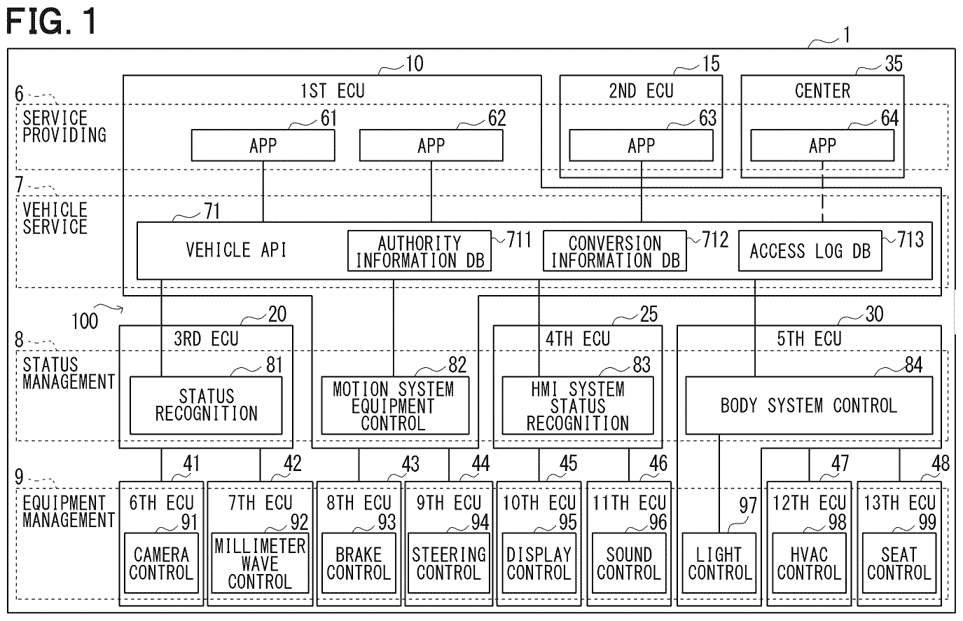

The vehicle control system 1 shown in FIG. 1 includes a group of electronic control units (hereinafter referred to as ECUs) 100 mounted on a vehicle such as an automobile, and a center 35. The ECU group 100 includes a plurality of ECUs. In the present embodiment, the ECU group 100 includes a first ECU 10, a second ECU 15, a third ECU 20, a fourth ECU 25, a fifth ECU 30, and sixth to thirteenth ECUs 41 to 48. Each ECU belonging to the ECU group 100 is connected to each other via in-vehicle communication (i.e., wired or wireless communication). The center 35 is provided outside the vehicle and is connected to the ECU group 100 via external communication (i.e., wireless communication).

The first ECU 10 has an in-vehicle communication relay function and, by supervising the second to fifth ECUs 15 to 30, achieves coordinated control of the entire vehicle. In addition, the first ECU 10 also supervises communication with the center 35, thereby achieving coordinated control of the overall system including the center 35.

The first ECU 10 and the third to fifth ECUs 20 to 30 are provided for each domain classified according to functions within the vehicle, and primarily execute control of a plurality of ECUs (i.e., any of the sixth to thirteenth ECUs 41 to 48) present within those domains. Examples of domains include the powertrain, body, chassis, and cockpit.

The sixth to thirteenth ECUs 41 to 48 control the vehicle equipment, which are devices installed in the vehicle. The vehicle equipment may include, in addition to hardware such as sensors and actuators, various storage devices for storing data, as well as software for implementing certain functions.

The first ECU 10 and the third to fifth ECUs 20 to 30 are each connected to their respective subordinate sixth to thirteenth ECUs 41 to 48 via individual lower-level networks (for example, CAN). CAN is an abbreviation for Controller Area Network and is a registered trademark. The first ECU 10 and the third to fifth ECUs 20 to 30 have functions for centrally managing access rights to their respective subordinate sixth to thirteenth ECUs 41 to 48, as well as for performing user authentication and the like.

In another embodiment, the vehicle control system 1 may include a group of ECUs 100, and the center 35 may be omitted. In another embodiment, the number of ECUs belonging to the ECU group 100 may be fourteen or more, or thirteen or fewer. In another embodiment, there may be a plurality of centers 35.

### (Hardware Configuration)

Next, the hardware configuration of each ECU belonging to the ECU group 100 and the center 35 will be described. Each ECU belonging to the ECU group 100 has the same hardware configuration. Therefore, the configuration of the first ECU 10 will be described as a representative example.

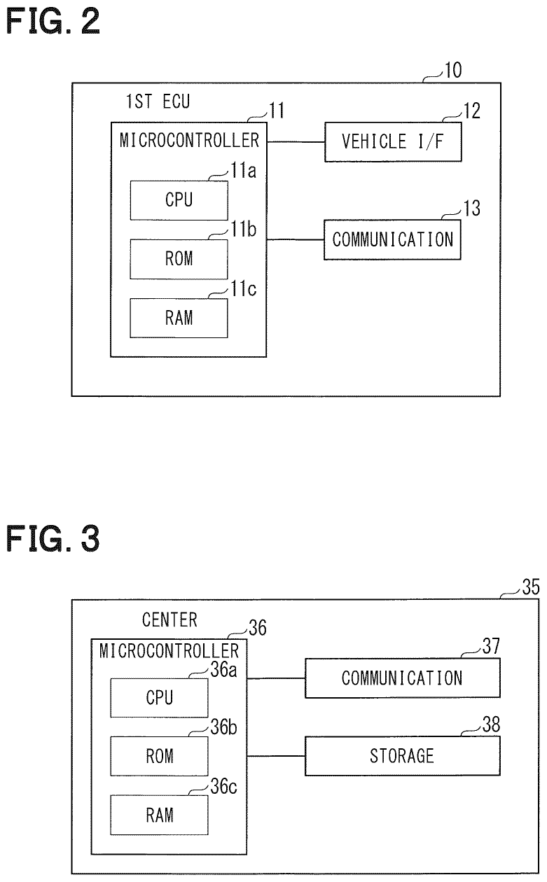

As shown in FIG. 2, the first ECU 10 includes a microcomputer 11, a vehicle interface (hereinafter referred to as I/F) 12, and a communication unit 13. The microcomputer 11 includes a CPU 11a, a ROM 11b, and a RAM 11c. The various functions of the first ECU 10 are implemented by the CPU 11a executing programs stored on a non-transitory tangible recording medium. In the present embodiment, the ROM 11b corresponds to the non-transitory tangible recording medium in which the program is stored. Further, by executing this program, a method corresponding to the program is carried out.

The vehicle I/F 12 is connected to other ECUs and in-vehicle devices via an in-vehicle network or the like, and acquires various types of information from the other ECUs and in-vehicle devices. The in-vehicle network may include a Controller Area Network (hereinafter referred to as CAN) and Ethernet. CAN is a registered trademark. Ethernet is a registered trademark.

The communication unit 13 performs data communication with the center 35 or the like via a wide-area communication network through wireless communication. However, the communication unit 13 does not need to be provided in all of the ECUs belonging to the ECU group 100, and may be provided in only one or some of the ECUs.

The methods for implementing the various functions provided by the first ECU 10 are not limited to software, and some or all of the elements may be implemented using one or more pieces of hardware. For example, when the above functions are implemented by electronic circuits as hardware, such electronic circuits may be realized by digital circuits including a large number of logic circuits, analog circuits, or a combination thereof.

As shown in FIG. 3, the center 35 includes a microcomputer 36, a communication unit 37, and a storage unit 38. The microcomputer 36 includes a CPU 36a, a ROM 36b, and a RAM 36c. The various functions of the center 35 are realized by the CPU 36a executing programs stored on a non-transitory tangible recording medium. In the present embodiment, the ROM 36b serves as the non-transitory tangible recording medium in which the program is stored. Further, by executing this program, a method corresponding to the program is performed.

The communication unit 37 performs data communication with the group of ECUs 100 via a wide-area communication network. The storage unit 38 is a storage device for storing vehicle data and the like provided by the group of ECUs 100.

The methods for realizing the various functions provided by the center 35 are not limited to software, and some or all of the elements may be implemented using one or more pieces of hardware. For example, when the above functions are implemented by electronic circuits as hardware, the electronic circuits may be realized by digital circuits including a plurality of logic circuits, analog circuits, or a combination thereof.

### (Functional Configuration)

Returning buck to FIG. 1, the various functions included in the vehicle control system 1 will be described. The software architecture of the vehicle control system 1 is structured into four layers. That is, the vehicle control system 1 includes the functions of an equipment management unit 9 in the first layer, a state management unit 8 in the second layer, a vehicle service unit 7 in the third layer, and a service providing unit 6 in the fourth layer. These functions provided by the vehicle control system 1 are distributed among the respective ECUs belonging to the ECU group 100, as well as the center 35.

### (Equipment Management Unit)

The equipment management unit 9 includes a plurality of control units 91 to 99 corresponding to multiple types of vehicle equipment. Vehicle equipment includes, for example, an onboard camera, an onboard millimeter-wave radar, a brake, steering, a display, a speaker, various lights, an onboard air conditioner, and an electric power seat.

Specifically, the equipment management unit 9 includes a camera control unit 91, a millimeter-wave control unit 92, a brake control unit 93, a steering control unit 94, a display control unit 95, an audio control unit 96, a light control unit 97, a Heating Ventilation and Air-Conditioning (hereinafter, HVAC) control unit 98, and a seat control unit 99. Each piece of vehicle equipment is individually controlled by the corresponding control unit among the control units 91 to 99.

The camera control unit 91 controls the exposure and other settings of the onboard camera to acquire captured images from the onboard camera. In the present embodiment, the sixth ECU 91 is provided with the camera control unit 91.

The millimeter-wave control unit 92 controls the onboard millimeter-wave radar to acquire detection results detected by the millimeter-wave radar. In the present embodiment, the seventh ECU 92 is provided with the millimeter-wave control unit 92.

The brake control unit 93 controls the brakes. In the present embodiment, the eighth ECU 93 is provided with the brake control unit 93.

The steer control unit 94 controls the steering. In the present embodiment, the ninth ECU 44 is provided with the steer control unit 94.

The display control unit 95 controls the display device (for example, a meter, warning lamp, etc.). In the present embodiment, the tenth ECU 45 is provided with the display control unit 95.

The sound control unit 96 controls the speaker to output sounds such as warning tones or voice from the speaker. In the present embodiment, the eleventh ECU 46 is provided with the sound control unit 96.

The light control unit 97 controls various lights installed on the vehicle. In the present embodiment, the fifth ECU 30 is provided with the light control unit 97.

The HAVC control unit 98 controls the vehicle-mounted air conditioner. In the present embodiment, the twelfth ECU 47 is provided with the HAVC control unit 98.

The seat control unit 99 controls the vehicle's electric power seats. In the present embodiment, the thirteenth ECU 48 is provided with the seat control unit 99.

The equipment management unit 9 operates the vehicle equipment in accordance with operation instructions from the status management unit 8, and notifies the status management unit 8 of the operation results. For example, when the vehicle equipment is an actuator, the operation results may indicate that the actuator has completed its operation normally, has failed, or other similar statuses. When the vehicle equipment is a sensor, the operation results may include data detected by the sensor. When the vehicle equipment is a storage device, the notification of the result may include data read from the storage device.

In addition to operating the vehicle equipment in accordance with operation instructions from the status management unit 8, the equipment management unit 9 may also be configured to autonomously detect the state of the vehicle equipment and notify the status management unit 8.

### (Status Management Unit)

The status management unit 8 includes a status recognition unit 81, a motion system equipment control unit 82, a Human Machine Interface (hereinafter, HMI) system status recognition unit 83, and a body system control unit 84. The status management unit 8 is classified not by means of implementation that tend to depend on vehicle variations (for example, control units 91 to 99), but rather according to vehicle operations that are more likely to be requested by the service providing unit 6. For example, the status management unit 8 may be provided for each domain of the vehicle.

The status recognition unit 81 performs operations to recognize the status of the vehicle itself and its surroundings, such as the positions of the vehicle and pedestrians. For example, the status recognition unit 81 targets as control objects, the vehicle equipment belonging to the camera control unit 91 and the millimeter wave control unit 92. In the present embodiment, the third ECU 20 includes the status recognition unit 81.

The motion system equipment control unit 82 corresponds to vehicle operations related to driving, such as turning, running, and stopping. The motion system equipment control unit 82, for example, targets as control objects, the vehicle equipment belonging to the brake control unit 93 and the steering control unit 94. In the present embodiment, the first ECU 10 includes the motion system equipment control unit 82.

The HMI system status recognition unit 83 corresponds to vehicle operations related to providing information to the user. The HMI system status recognition unit 83, for example, targets as control objects, the vehicle equipment belonging to the display control unit 95 and the sound control unit 96. In the present embodiment, the fourth ECU 25 includes the HMI system status recognition unit 83.

The body system control unit 84 corresponds to body system vehicle operations related to the vehicle environment. The body system control unit 84, for example, targets as control objects, the vehicle equipment belonging to the light control unit 97, the HVAC control unit 98, and the seat control unit 99. In the present embodiment, the fifth ECU 30 includes the body system control unit 84.

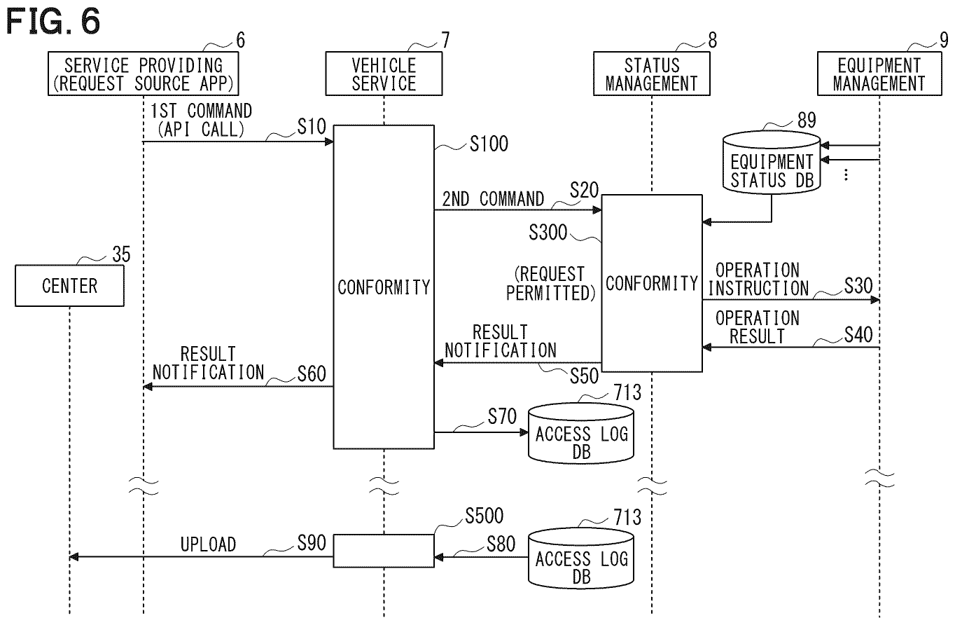

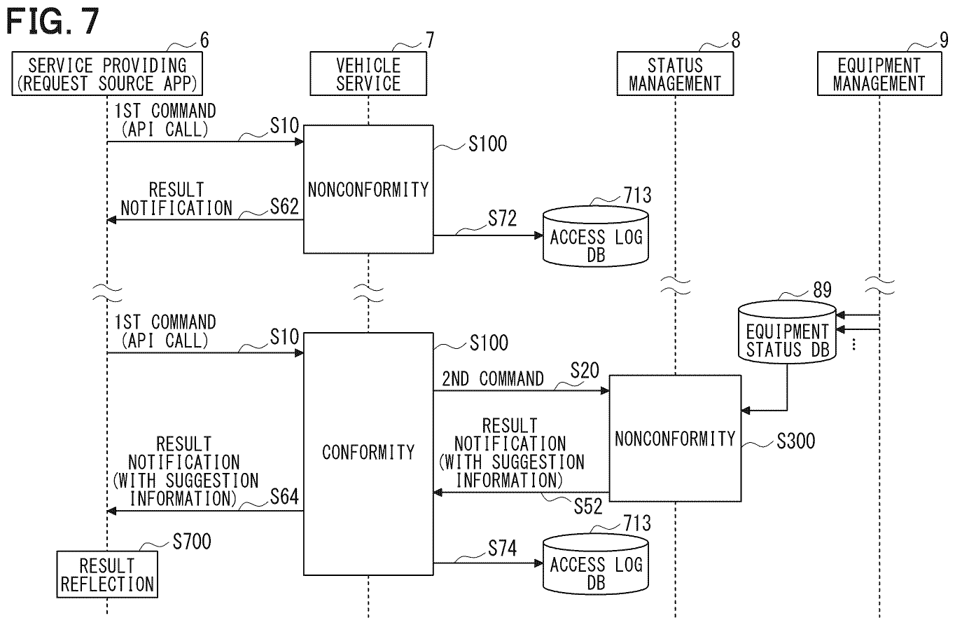

As shown in FIG. 6 and FIG. 7, the state management unit 8 includes an equipment status database (hereinafter referred to as the equipment status DB) 89 for storing the status of each vehicle equipment detected by the equipment management unit 9. Both dynamic information and static information are stored in the equipment status DB 89. The dynamic information includes details such as whether the vehicle equipment is in an operable state or not, and whether the vehicle equipment is malfunctioning or not. The operable state of the vehicle equipment may include, for example, a state in which the power is turned on, and a state in which communication with other ECUs is possible. The static information includes details such as the model number of each vehicle equipment and the specifications of each vehicle equipment.

When the status management unit 8 receives a request (i.e., a second command) from the vehicle service unit 7, the status management unit 8 executes the second determination process S300. The second determination process S300 determines whether the specific vehicle equipment indicated by the second command (i.e., the target equipment) and the current scene are suitable for realizing the requested function, and if both are suitable, the status management unit 8 instructs the equipment management unit 9 to operate the target equipment. Details of the second determination process S300 will be described later.

The status management unit 8 outputs an operation instruction to the equipment management unit 9, and provides the operation result returned from the equipment management unit 9 to the vehicle service unit 7 as a result notification in response to the second command. The result notification may use each individual operation result as is, or may integrate multiple operation results and convert them into higher-level abstract data for use.

For example, the status management unit 8 may receive a request for information collection from the vehicle service unit 7 to grasp the state of the vehicle, and in response, may obtain data from multiple pieces of vehicle equipment as operation results from the equipment management unit 9. When the multiple pieces of data obtained from the vehicle equipment as operation results are “vehicle speed is 0 km/h,” “shift position is P,” and “no driver is present in the vehicle,” these may be converted into data indicating that “the vehicle is in a parked state.”

### (Service Providing Unit)

The service providing unit 6 realizes various functions, such as information collection, theft prevention, and remote operation, by executing application software (hereinafter referred to as “apps”) 61 to 64 and utilizing vehicle equipment managed by the equipment management unit 9.

In the present embodiment, the first ECU 10, the second ECU 15, and the center 35 are provided with the service providing unit 6. The ROM 11b of the first ECU 10 stores the apps 61 and 62. The ROM 11b of the second ECU 15 stores the app 63. The ROM 36b of the center 35 stores the app 64.

Basically, the apps 61 to 64 are configured to obtain information indicating the state of the vehicle via the vehicle API 71, which constitutes the vehicle service unit 7, and, in accordance with the confirmed vehicle state, to realize the intended function through a series of operations that control certain vehicle equipment via the vehicle API 71.

The apps 61 to 64 are not dedicated programs for executing processing suited to specific vehicle models or specific grades, but are general-purpose programs for executing processing suited to a wide range of vehicle models, grades, and the like. Accordingly, the apps 61 to 64 are described using the functions of a modeled vehicle that have been generally disclosed, so that they can be created without consideration of the individual vehicle equipment or performance possessed by each vehicle. In other words, the apps 61 to 64 can be easily developed even by third parties who are app providers other than OEMs, and the developed products can also be widely released. Accordingly, a vehicle user who owns a vehicle equipped with the ECU group 100 can install apps released by third parties onto any of the ECUs in the ECU group 100 via a wide-area communication network or the like. In addition, the vehicle user can arbitrarily add or modify the apps 61 to 64.

In the case of apps used to provide services that obtain vehicle information from many vehicles and analyze vehicle behavior, driver operations, and the like, the service provider, who is the app provider, may install the app on any of the ECUs in the ECU group 100 with the permission of the vehicle user. In addition, when accessing the vehicle API 71 from an app installed in the center 35 by a service provider or the like, access permissions to each vehicle API 71 may be restricted by the vehicle user on a per-service-provider or per-app basis.

### (Vehicle Service Unit)

The vehicle service unit 7 includes a vehicle Application Programming Interface (hereinafter referred to as API) 71. The vehicle API 71 is an interface for accessing the functions provided by the vehicle. In the present embodiment, the first ECU 10 is provided with the vehicle API 71.

The vehicle API 71 has a standardized syntax that allows requests to be described without depending on a specific vehicle model or specific grade. When utilizing the functions provided by the vehicle API 71, the applications 61 to 64 transmit a first command to the vehicle API 71. The first command is a command that specifies the information required when using the vehicle API 71. The first command may include a command indicating the content of the request, instructions such as arguments, and function calls, among others. The first command may also include priority information indicating which command should be processed preferentially. The syntax of the API, that is, the format of the first command, is described using generally published, modeled vehicle functions so that, like applications 61 to 64, it can be created without regard to the specific vehicle equipment or performance possessed by individual vehicles.

When the vehicle API 71 receives the first command, the vehicle API 71 executes the first determination process S100. In the first determination process S100, it is determined, from a formal perspective, whether the first command can be accepted, based on factors such as the format of the first command and the access rights possessed by the source of the request. If the vehicle API 71 determines that the command can be accepted, the vehicle API 71 converts the first command into a second command described in a format suitable for the target vehicle's model, grade, and the like, and then transmits it to the state management unit 8. In other words, the vehicle API 71 has the function of converting the first command, which is described in a standard format handled by the service providing unit 6, into a second command described in a vehicle-specific format handled by the state management unit 8 and the equipment management unit 9. In addition, the vehicle API 71 has a function of forwarding the result notification, which is a response from the state management unit 8 to the second command, to the requesting application. Details of the first determination process S100 will be described later.

The vehicle API 71 is provided with an authorization information DB 711, a conversion information DB 712, and an access log DB 713.

The authorization information DB 711 stores the authorization information granted to each of the applications 61 to 64 belonging to the service providing unit 6. The authorization information is information indicating the contents of the access rights granted to each of the applications 61 to 64. The authorization information may include the range of functions or data that can be accessed, as well as the period during which access is permitted, and the like.

The conversion information DB 712 stores format information and conversion information. The format information includes the format of the first command defined as a standard format. The conversion information includes information for converting the first command into a second command in a vehicle-specific format. It should be noted that the authorization information, standard information, and conversion information may be obtained from the center 35 or another external server via a wide area communication network.

The access log DB 713 stores access logs generated in the first determination process S100.

### (Processing)

### (First Determination Process)

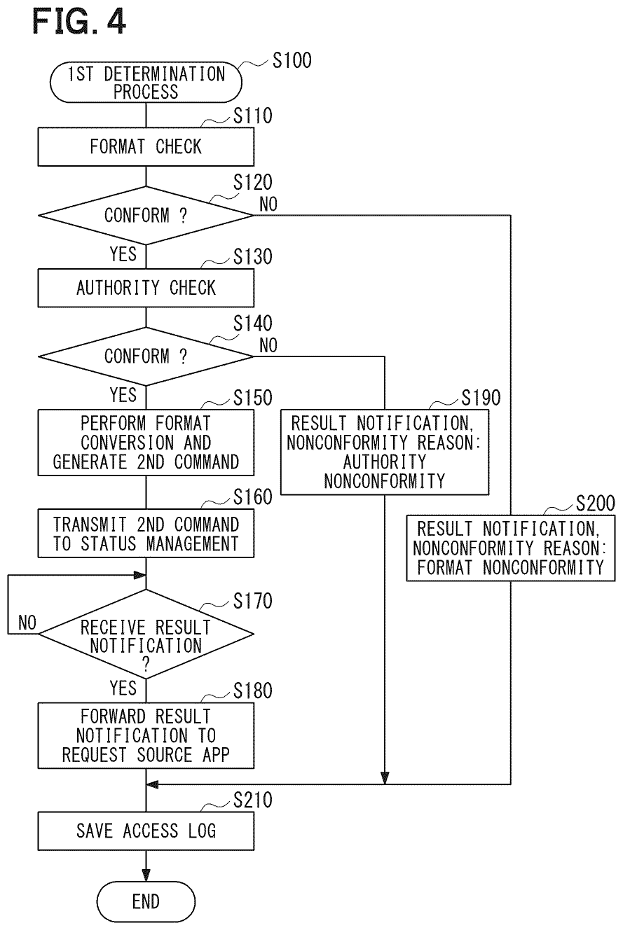

The first determination process S100 executed by the vehicle service unit 7 will be explained with reference to the flowchart in FIG. 4. The first determination process S100 is initiated when the vehicle service unit 7 receives a first command, which is a request from the service providing unit 6, via the vehicle API 71. Hereinafter, the application that is the source of the first command is referred to as the requesting application.

It should be noted that the first command describes the function to be realized in an abstract manner, without specifying any particular vehicle equipment or using expressions dependent on the performance of the vehicle equipment. For example, the first command may specify to turn on the car finder, but it does not designate which of the multiple lights installed in the vehicle should be turned on or how to control specific vehicle equipment. Concrete matters that depend on the individual vehicle, such as which equipment to operate and in what manner, are not specified.

When the first determination process S100 is initiated, in S110, the vehicle service unit 7 performs a format check on the received first command. The format check is performed by comparing the data indicated in the first command with the format information representing the syntax of the specified API stored in the conversion information DB 712.

In the subsequent S120, the vehicle service unit 7 determines, based on the result of the format check, whether the data indicated in the first command conforms to the syntax of the API. If it is determined to conform, the process proceeds to S130. If it is determined not to conform, the process proceeds to S200.

In S200, the vehicle service unit 7 sends a result notification indicating rejection of the request to the requesting application, citing nonconformity of format as the reason for nonconformity, and then proceeds to S210.

In S130, the vehicle service unit 7 performs an authority check on the requesting application. The authority check is performed by comparing the content of the request in the first command with the content of the authority information stored in the authority information DB 711, that is, the access rights possessed by the requesting application of the first command.

In the subsequent S140, the vehicle service unit 7 determines, based on the result of the authority check, whether the request in the first command conforms to the access rights possessed by the requesting application of the first command. If it is determined to conform, the process proceeds to S150. If it is determined not to conform, the process proceeds to S190.

In S190, the vehicle service unit 7 sends a result notification to the requesting application indicating rejection of the request due to nonconformity of authority as the reason for nonconformity, and then proceeds to S210.

In S150, the vehicle service unit 7 converts the first command into a second command, which is in a vehicle-adapted proprietary format, namely, a format that can be interpreted by the state management unit 8 and the equipment management unit 9, using the conversion information stored in the conversion information DB 712. In the second command, a specific vehicle device to be controlled may be designated. Additionally, when the control target is an actuator, a specific control value may be designated. When the control target is a storage device, the address to be subjected to data read/write may be designated.

In the subsequent S160, the vehicle service unit 7 transmits the generated second command to the state management unit 8.

In the subsequent S170, the vehicle service unit 7 waits until the vehicle service unit 7 receives a result notification, which is a response to the transmitted second command, from the destination state management unit 8. Upon receiving the result notification, it proceeds to S180.

In S180, the vehicle service unit 7 forwards the result notification received from the state management unit 8 to the requesting application, and then proceeds to S210.

In S210, the vehicle service unit 7 stores the access log in the access log DB 713 and terminates the process. The access log is data that associates the content of the result notification, which was obtained or generated by any of S180 to S200, with the content of the first command that served as the basis for the result notification. It should be noted that the vehicle service unit 7 may store only access logs related to result notifications indicating rejection of requests in the access log DB 713.

### (Second Determination Processing)

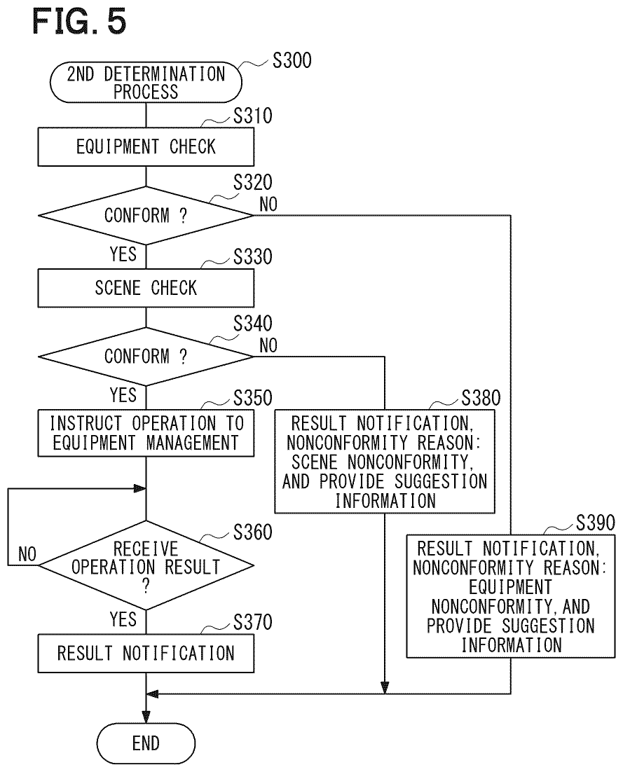

The second determination processing S300 executed by the state management unit 8 will be described with reference to the flowchart shown in FIG. 5. The second determination processing S300 is initiated when the state management unit 8 receives a second command, which is a request from the vehicle service unit 7.

When the second determination processing S300 is initiated, in S310, the state management unit 8 performs an equipment check on the content of the received second command. The equipment check determines whether the request indicated in the second command can be fulfilled by the vehicle equipment to be controlled (hereinafter referred to as the target equipment) specified in the second command. Specifically, by referring to the information stored in the equipment status DB 89, it is checked whether the target equipment exists, whether the target equipment is malfunctioning, and whether the target equipment has the capability to fulfill the requested operation, among other factors.

In the subsequent S320, if the state management unit 8 determines, as a result of the equipment check, that the target equipment is suitable for fulfilling the request, the processing proceeds to S330. If it determines that the equipment is unsuitable, the processing proceeds to S390.

In S390, the state management unit 8 indicates that the request is rejected on the grounds of equipment nonconformity as the reason for nonconformity, and sends a result notification, with suggestion information attached, to the vehicle service unit 7, thereby ending the process. The suggestion information indicates how the reason for equipment nonconformity can be resolved. For example, if the target equipment does not exist or if the target equipment lacks sufficient capability, the suggestion information may include the model number of equipment suitable for the request, the version of software to be applied to the target equipment, and the like. In addition, if some of the multiple target equipment are malfunctioning, the suggestion information may include information for identifying the operational vehicle equipment. The suggestion information is generated based on various types of information stored in the equipment status DB.

In S330, the status management unit 8 performs a scene check. The scene check determines whether the situation of the vehicle corresponds to a scene in which the request according to the second command can be executed. Scenes in which the request can be executed are, for example, restricted for reasons such as safety. Additionally, the scene is estimated, for example, based on the status of each vehicle equipment stored in the equipment status DB 89.

In the subsequent S340, if the status management unit 8 determines, as a result of the scene check, that the scene conforms to the request of the second command, the process proceeds to S350; if it determines that the scene does not conform, the process proceeds to S380.

In S380, it is indicated that the status management unit 8 rejects the request on the grounds of scene nonconformity as the reason for nonconformance, and sends a result notification, to which suggestion information is appended, to the vehicle service unit 7, thereby ending the process. The suggestion information is information indicating how the reason for scene nonconformity can be resolved. The suggestion information may include, for example, information indicating scenes in which the request can be accepted.

In S350, the status management unit 8 sends a specific command, which is generated based on the second command and directed to the target equipment, to the equipment management unit 9.

In the subsequent S360, the status management unit 8 waits until the status management unit 8 receives a response to the sent command from the destination equipment management unit 9. Upon receiving the response, it proceeds to S370 for further processing.

In S370, the status management unit 8 generates a result notification according to the response from the equipment management unit 9, and sends the generated result notification to the vehicle service unit 7, thereby completing the processing. The response from the equipment management unit 9 may indicate the execution result of the command. For example, the response from the equipment management unit 9 to a command for driving an actuator or the like may indicate whether the operation was successful or failed. In addition, the response from the equipment management unit 9 to a command for data access may indicate the success or failure of the data read/write operation, and may also include the read data or the like.

### (Operation)

### (Basic Operation)

Next, the basic operation of the vehicle control system 1 will be described with reference to the sequence diagram of FIG. 6.

It should be noted that the equipment management unit 9 monitors the status of the vehicle equipment and stores the monitoring results in the equipment status DB 89, which is accessible from the status management unit 8. The monitoring results are repeatedly updated at least each time there is a change in status.

As shown in FIG. 6, in S10, the application belonging to the service providing unit 6 uses the vehicle API to transmit a first command to the vehicle service unit 7, requesting execution of a desired function.

The vehicle service unit 7 executes a first determination process S100 for the received first command. If, in the first determination process S100, both the format check and the authority check are determined to be appropriate, then in S20, the vehicle service unit 7 uses the conversion information to convert the first command into a second command and transmits it to the status management unit 8.

The status management unit 8 executes a second determination process S300 for the received second command. If, in the second determination process S300, both the equipment check and the scene check are determined to be appropriate, then in S30, the status management unit 8 transmits an operation instruction for the target equipment to the equipment management unit 9 in accordance with the second command.

The equipment management unit 9 operates the target equipment in accordance with the received operation instruction, and in S40, transmits the operation result to the status management unit 8.

The status management unit 8 generates a result notification based on the operation result, and in S50, transmits the result notification to the vehicle service unit 7.

The vehicle service unit 7 transmits the received result notification to the requesting application of the service providing unit 6 in S70. Further, in S80, the vehicle service unit 7 generates an access log that associates the content of the result notification with the content of the first command received in S10, and records the generated access log in the access log DB 713. It should be noted that, if the result notification indicates that the request based on the first command has been successfully implemented, the recording of the access log may be omitted.

The vehicle service unit 7 executes a log providing process S500 separately from the first determination process S100. In the log providing process S500, when a predetermined transmission condition is satisfied, the vehicle service unit 7 acquires the access log from the access log DB 713 in S80 and uploads it to the center 35 in S90. The transmission conditions may include the elapse of a certain period of time, the number of accumulated access logs reaching a predetermined amount, or a request from the center 35, and the like.

### (Request Rejection Operation)

With reference to the sequence diagram of FIG. 7, the operation in the case where nonconformity is determined in the first determination processing or the second determination processing will be described.

The vehicle service unit 7 executes the first determination process S100 on the first command received from the service providing unit 6. If, in the first determination process S100, the result of the format check or the authority check is determined to be nonconforming, the vehicle service unit 7, in S62, transmits a result notification indicating the reason for nonconformity to the requesting application belonging to the service providing unit 6. Furthermore, in S72, the vehicle service unit 7 generates an access log associating the content of the result notification with the first command received in S10, and stores the generated access log in the access log DB 713.

If, in the first determination process S100, the result of the format check or the authority check is determined to be conforming, then in S20, the vehicle service unit 7 transmits a second command to the state management unit 8.

The state management unit 8 executes a second determination process on the second command received from the vehicle service unit 7. If, in the second determination process S300, the result of the equipment check or scene check is determined to be nonconforming, then in S52, the state management unit 8 transmits a result notification, in which the reason for nonconformity is indicated and suggestion information is appended, to the vehicle service unit 7.

In S64, the vehicle service unit 7 transmits the result notification received from the state management unit 8 to the service providing unit 6 (i.e., the requesting application). Additionally, in S74, the vehicle service unit 7 generates an access log that associates the contents of the result notification with the first command received in S10, and stores the generated access log in the access log DB 713.

The requesting application may execute a result reflection process S700, in which the contents of the suggestion information indicated in the received result notification are reflected in subsequent processing. In the result reflection process S700, for example, a first command with partially modified request content or transmission timing may be resent in accordance with the contents of the suggestion information.

### Specific Example

The operation will be described for a situation in which, in a vehicle equipped with seat heaters for the driver's seat, front passenger seat, and rear seat, the seat heater for the rear seat is malfunctioning, and the requesting application transmits a first command to the vehicle service unit 7 requesting activation of all seat heaters.

If the requesting application does not have the authority to request activation of the seat heaters, the authority check in the first determination process S100 will determine that the request based on the first command is noncompliant, and a result notification indicating rejection of the request due to lack of authority as the reason for noncompliance will be returned. In this case, since there is no authority in the first place and there are no situations in which acceptance would be possible without the necessary authority, suggestion information does not need to be appended to the result notification.

If, as a result of the format check and authority check in the first determination process S100, the first command is determined to be compliant, the first command is converted into a second command that requests activation of the specific target equipment and is transmitted to the state management unit 8. The specific target equipment may include, for example, the seat heaters for the driver's seat, front passenger seat, and rear seat.

For example, if the seat heater for the rear seat is malfunctioning, the equipment check in the second determination process S300 will determine that the request based on the second command is noncompliant, and a result notification indicating rejection of the request due to equipment nonconformity as the reason for noncompliance will be sent. In this case, suggestion information indicating that the seat heaters for the driver's seat and front passenger seat, for which no malfunction has been detected, are operable as the range of equipment for which requests can be accepted, may be appended to the result notification.

In cases where the second command is rejected due to a critical malfunction affecting all commands, such as being unable to access the equipment status DB89, which serves as the information source for the second determination process S300, because of a vehicle communication failure, suggestion information indicating improvements or the like for individual commands may not be appended.

Next, the operation in a situation where the vehicle is in motion and the requesting application sends a first command, requesting door unlocking, to the vehicle service unit 7 will be described.

As a result of the scene check in the second determination process S300, a result notification rejecting the request of the second command on the grounds of scene nonconformity as the reason for noncompliance is sent. In this case, suggestion information indicating that the scenes in which door unlocking can be executed are when the vehicle is stopped or parked may be appended to the result notification.

Next, the operation in a situation where the vehicle's battery voltage is in a low-voltage state and the requesting application sends some first command involving power consumption to the vehicle service unit 7 will be described.

As a result of the scene check in the second determination process S300, a result notification rejecting the request for the second command on the grounds of scene nonconformity as the reason for noncompliance is sent. In this case, the result notification may include, as suggestion information, the acceptable voltage at which the request can be accepted and the estimated time required for the battery voltage to recover to the acceptable voltage, among other information.

The first determination process S100 of the vehicle service unit 7 in the present embodiment corresponds to the reception unit of the present disclosure; the second determination process S300 of the state management unit 8 corresponds to the determination unit of the present disclosure; and the log providing process S500 of the vehicle service unit 7 corresponds to the log providing unit of the present disclosure. In addition, the access log DB 713 in the present embodiment corresponds to the log storage unit of the present disclosure.

According to the embodiments described in detail above, the following effects are achieved.

(1) In the vehicle control system 1, when a request (i.e., a first command) from the service providing unit 6 via the vehicle API 71 is rejected, a result notification including not only the reason for nonconformity that caused the rejection but also suggestion information, that is, information indicating how conformity can be achieved, is transmitted to the requesting application. Accordingly, the requesting application can accurately utilize the functions provided by the vehicle by modifying the way it makes requests to the vehicle API 71 in accordance with the suggestion information.

(2) In the vehicle control system 1, an access log, which is information associating the content of the result notification with the content of the first command, is stored in the access log DB 713 and is configured so that it can be provided outside the vehicle as necessary. Accordingly, service providers offering applications can obtain specific information regarding points for improvement of the application by acquiring the access log, which can be utilized to enhance application quality and increase the value provided by the application. In addition, by utilizing the access log, it is also possible to enable consulting businesses aimed at service providers for the purpose of application improvement.

### Other Embodiments

The embodiments of the present disclosure have been described above; however, the present disclosure is not limited to the above-described embodiments and may be implemented in various modified forms.
(a) In the above embodiment, an example was given in which the conversion from the first command to the second command is performed by the vehicle service unit 7; however, for example, it may also be performed by the state management unit 8.
(b) In the above embodiment, “format nonconformity,” “authorization nonconformity,” “equipment nonconformity,” and “scene nonconformity” were given as examples of reasons for nonconformity; however, for example, “priority nonconformity,” “communication timeout,” and the like may also be included. If the reason for nonconformity is “priority nonconformity,” the suggestion information may indicate the priority level that would be determined as conforming.
(c) In the above embodiment, the first ECU 10, the second ECU 15, and the center 35 are each provided with a service providing unit 6, and the first ECU 10 is provided with a vehicle service unit 7. In addition, the first ECU 10 and the third to fifth ECUs 20 to 30 are provided with a state management unit 8, and the fifth to thirteenth ECUs 30 to 48 are provided with an equipment management unit 9. The number of ECUs belonging to the ECU group 100, as well as the allocation of the functions of the service providing unit 6, the vehicle service unit 7, the state management unit 8, and the equipment management unit 9 to each ECU, are not limited to the examples given in the embodiment and may be determined as desired.
(d) The multiple functions possessed by a single component in the above embodiment may be realized by a plurality of components, or a single function possessed by a single component may be realized by a plurality of components. In addition, multiple functions possessed by a plurality of components may be realized by a single component, or a single function realized by a plurality of components may be realized by a single component. It is also possible to omit a part of the configuration of the above embodiment. In addition, at least a part of the configuration of the above embodiment may be added to or substituted for the configuration of another embodiment described above.
(e) In addition to the above-described vehicle control device, the present disclosure can also be implemented in various forms such as a program for causing a computer to function as a vehicle control device, a non-transitory tangible recording medium such as a semiconductor memory in which this program is recorded, or a vehicle control method.

What is claimed is:

1. A vehicle control device mounted on a vehicle, comprising:
at least one of (i) a circuit and (ii) a processor with a memory storing computer program code executable by the processor, the at least one of the circuit and the processor configured to cause the vehicle control device to:
perform at least one of: executing control of vehicle equipment possessed by the vehicle, and managing a state of the vehicle equipment;
receive, from a service providing unit that executes application software, a first command, which is described in a standardized format and requests implementation of a target function utilizing the vehicle equipment, and to convert the first command into a second command described in a format executable by the vehicle; and
determine whether the target function can be implemented, and, when implementation is possible, to cause the vehicle control device to execute an instruction according to the second command, and when the implementation is not possible, to transmit, together with a nonconformity reason indicating a reason for infeasibility, suggestion information indicating requirement necessary for the target function to be determined feasible, to a requester of the first command,
wherein
the nonconformity reason includes: an equipment nonconformity indicating that the vehicle equipment is unsuitable for implementing the target function; a scene nonconformity indicating that a scene identified from the state of the vehicle is unsuitable for implementing the target function; and an authorization nonconformity indicating that the requester of the first command does not have authority to use the target function, and
the at least one of the circuit and the processor is configured to add the suggestion information when the nonconformity reason is either the equipment nonconformity or the scene nonconformity.

2. The vehicle control device according to claim 1, wherein
when the nonconformity reason is the equipment nonconformity, the suggestion information includes information indicating the vehicle equipment that is conforming.

3. The vehicle control device according to claim 1, wherein
when the nonconformity reason is the scene nonconformity, the suggestion information includes information indicating the scene that is conforming.

4. The vehicle control device according to claim 1, further comprising
a log storage unit configured to store an access log associating the nonconformity reason, which is generated and the suggestion information with information related to the target function that is a subject of a determination.

5. The vehicle control device according to claim 4, wherein
the at least one of the circuit and the processor is further configured to cause the vehicle control device to read out the access log stored in the log storage unit in response to a request from outside the vehicle and to provide to a requester.

6. A vehicle control method for a vehicle comprising an equipment management unit configured to perform at least one of execution of control of vehicle equipment and management of a state of the vehicle equipment, the method comprising:
receiving, from a service providing unit that executes application software, a first command described in a standardized format and requesting implementation of a target function that utilizes the vehicle equipment, and converting the first command into a second command described in a format executable by the vehicle; and
determining whether the target function can be implemented, causing the equipment management unit to execute an instruction according to the second command when implementation is possible, and notifying, together with a nonconformity reason indicating a reason for infeasibility, suggestion information indicating requirement necessary for the target function to be determined feasible, to a requester of the first command when implementation is not possible,
wherein
the nonconformity reason includes: an equipment nonconformity indicating that the vehicle equipment is unsuitable for implementing the target function; a scene nonconformity indicating that a scene identified from the state of the vehicle is unsuitable for implementing the target function; and an authorization nonconformity indicating that the requester of the first command does not have authority to use the target function, and
when the nonconformity reason is either the equipment nonconformity or the scene nonconformity, the suggestion information is added to a notification to the requester of the first command.
